(19) United States
(12) Patent Application Publication
(10) Pub. No.: US 2009/0082750 A1
(43) Pub. Date: Mar. 26, 2009

(54) FLUID TRANSFER DEVICES FOR USE WITH CARTRIDGES

(75) Inventors: Igor Denenburg, Riga District (LV); Niv Ben Shalom, Netanya (IL); Freddy Zinger, Ra'anana (IL)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: MEDIMOP MEDICAL PROJECTS LTD., Ra ’anana (IL)

(21) Appl. No.: 12/293,122

(22) PCT Filed: Mar. 15, 2007
(86) PCT No.: PCT/IL2007/000343

§ 371 Date: Dec. 16, 2008

(30) Foreign Application Priority Data
Mar. 16, 2006 (IL) 174352

(51) Int. Cl. A61J 1/22; A61J 1/20

(52) U.S. Cl. 604/407; 604/414

(57) ABSTRACT

Fluid transfer devices for use with syringes and cartridges having an open ended tube hermetically sealed by a rubber stopper and a slidable seal at opposite leading and trailing ends, respectively. The fluid transfer devices include a syringe port and a cartridge port for correspondingly slidingly receiving a syringe and a cartridge. The cartridge port preferably includes a primary puncturing member and a secondary puncturing member for correspondingly puncturing a cartridge's rubber stopper offset from its center for fluid transfer purposes between a syringe and a cartridge, and venting purposes. The fluid transfer devices are preferably used with stopping devices for preventing ejection of a cartridge's seal during a filling procedure.

### FIELD OF THE INVENTION

The invention pertains to fluid transfer devices for medical purposes.

### BACKGROUND OF THE INVENTION

Auto-injectors for self-administration of liquid drugs such as insulin typically employ so-called carpules or cartridges. Cartridges can contain a single dosage or multiple dosages and be provided in sterile packaging. Home users can be provided with empty cartridges requiring filling or pre-filled cartridges.

U.S. Pat. No. 6,752,180 to Delay illustrates and describes a device for enabling bidirectional transfer of a liquid between a vial and a cartridge. The device is commercially available under the tradename Mixset from Sedat, France. See http://www.sedat.com/siteGB/industrie-mixset-gb.html.

### SUMMARY OF THE INVENTION

The present invention is directed toward fluid transfer devices for use with syringes and cartridges having an open ended tube hermetically sealed by a rubber stopper and a slidable seal at opposite leading and trailing ends, respectively. The fluid transfer devices include a syringe port and a cartridge port for correspondingly slidingly receiving a syringe and a cartridge. The fluid transfer devices are preferably used with stopping devices for preventing ejection of a cartridge's seal during a filling procedure.

The cartridge ports preferably include a primary hollow puncturing member and a secondary hollow puncturing member for correspondingly puncturing a cartridge's rubber stopper offset from its center for fluid transfer purposes between a syringe and a cartridge, and venting purposes. The puncturing members are preferably constituted by hollow metal needles having an outer diameter of, say, about 0.5 mm to minimize possible leakage.

### BRIEF DESCRIPTION OF THE DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1A is a pictorial representation of a syringe, a cartridge with a plug, and a fluid transfer device for direct flow communication between the syringe and the cartridge;

FIG. 1B is a pictorial representation of a fluid transfer device with a cap for use with the syringe, the cartridge, and a vial;

FIG. 2 is a longitudinal cross section of a non-vented embodiment of FIG. 1A's fluid transfer device along line A-A in FIG. 1A for direct flow communication between a syringe and a cartridge;

FIG. 3 is a longitudinal cross section of a vented embodiment of FIG. 1A's fluid transfer device along line A-A in FIG. 1A for direct flow communication between a syringe and a cartridge;

FIG. 4 is a close-up view of FIG. 3's fluid transfer device's cartridge port including its primary puncturing member and secondary puncturing member encircled by a circle C in FIG. 3; and

FIG. 5 is a longitudinal cross section of FIG. 1B's fluid transfer device along line B-B in FIG. 1B.

### DETAILED DESCRIPTION OF THE DRAWINGS OF THE PREFERRED EMBODIMENTS

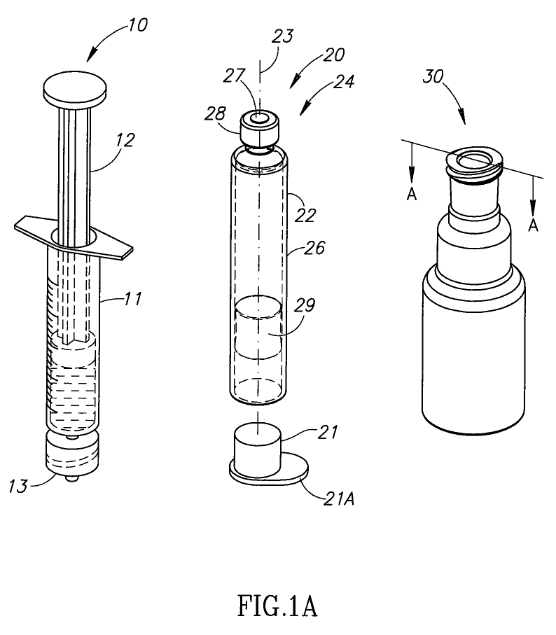

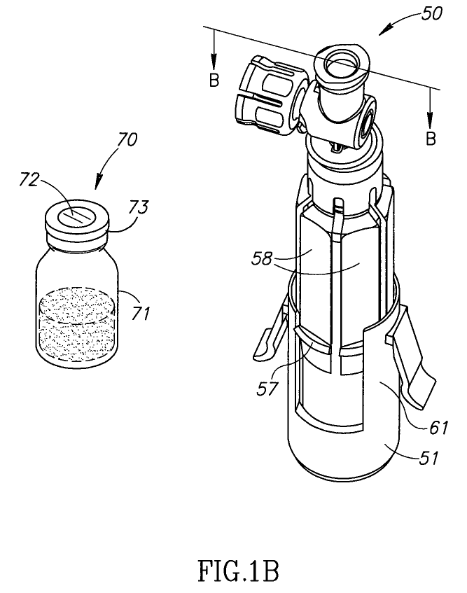

FIG. 1A shows a syringe 10, a cartridge 20 with a plug 21 with a tab 21A for ease of manipulation, and a fluid transfer device 30 for use with the syringe 10 and the cartridge 20. The syringe 10 includes a barrel 11 with a plunger 12, and a male Luer lock connector 13. The syringe 10 can be formed with other types of male connectors. The cartridge 20 includes an open ended tube 22 having a longitudinal axis 23, a small diameter leading end 24 and a wide diameter trailing end 26. The leading end 24 is hermetically sealed by a rubber stopper 27 capped by a metal band 28 leaving a small exposed circular rubber surface of between about 2 mm and about 3 mm in diameter. The trailing end 26 is hermetically sealed by a slidable seal 29. The plug 21 is shaped and dimensioned to be slidingly inserted into the tube's trailing end 26.

FIG. 1B shows a fluid transfer device 50 with a cap 51 for use with the syringe 10, the cartridge 20, and a vial 70 including an opened topped bottle 71 hermetically sealed by a rubber stopper 72 capped by a metal band 73. The fluid transfer device 50 is similar in construction and operation to fluid control devices with rotationally detachable vial adapters as illustrated and described in commonly assigned U.S. Pat. No. 6,238,372 to Zinger et al's FIGS. 11 to 15. Such fluid control devices are commercially available under the registered trademark MIXJECT® from Medimop Medical Projects Ltd, Ra'anana, Israel.

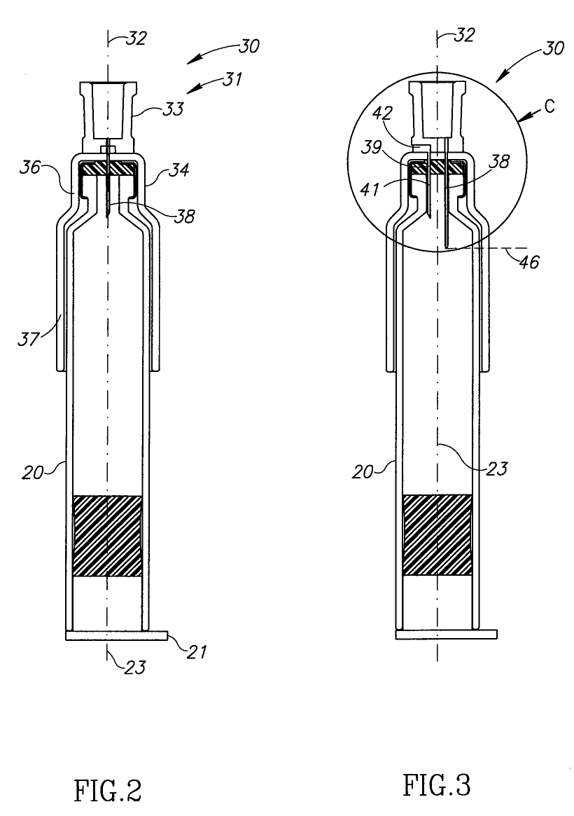

FIG. 2 shows a non-vented embodiment of the fluid transfer device 30 including a housing 31 having a longitudinal axis 32 for co-axial alignment with a cartridge's longitudinal axis 23, and a syringe port 33 and a cartridge port 34 co-directional with the longitudinal axis 32 and correspondingly slidingly receiving a syringe 10 and a cartridge 20. The syringe port 33 is preferably formed as a female Luer connector for sealingly receiving the syringe's male Luer lock connector 13. The cartridge port 34 has a stepped internal cross section including a leading portion 36 adjacent the syringe port 33 for snugly receiving the cartridge's leading end 24 and a trailing portion 37 remote from the syringe port 33 for snugly receiving the upper portion of cartridge's trailing end 26. The cartridge port 34 includes an axially directed primary puncturing member 38 in direct continuous flow communication with the syringe port 33. The puncturing member 38 is preferably constituted by a small diameter hollow metal needle co-axial with the fluid transfer device's longitudinal axis 32. The puncturing member 38 punctures the cartridge's rubber stopper 27 on sliding insertion of the cartridge 20 into the cartridge port 34, thereby effecting flow communication between the syringe port 33 and the inserted cartridge 20.

The fluid transfer device 30 can be optionally used with the plug 21 for stopping ejection of a cartridge's seal 29 during a filling procedure for filling with a cartridge with a liquid drug on injection of same from a syringe 10. Cartridges 20 can be supplied with pre-installed plugs 21. Plugs 21 can be provided in different lengths for stopping seals 29 at different volumes.

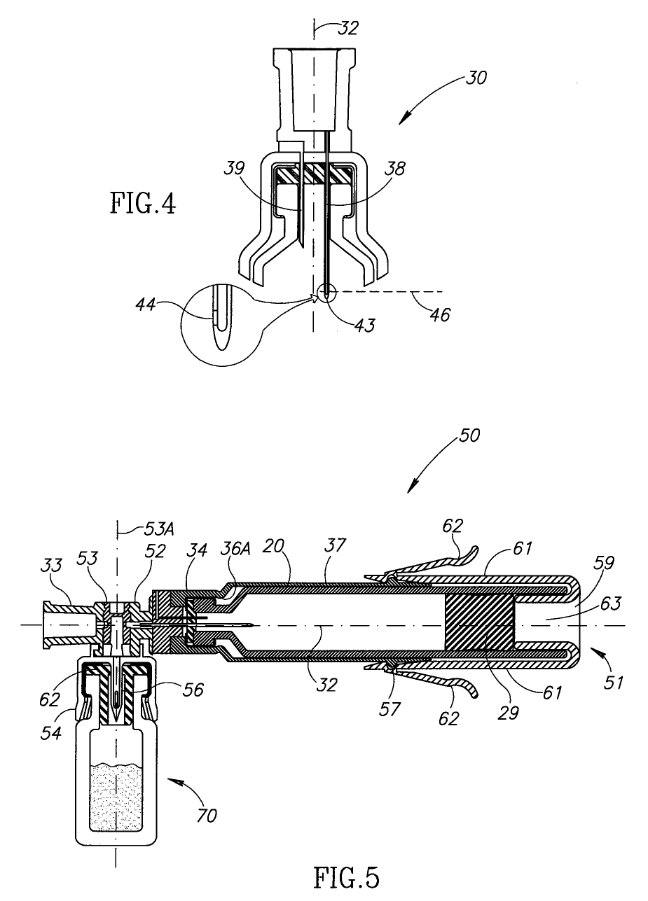

FIG. 3 shows a vented embodiment of the fluid transfer device 30 similar to its counterpart non-vented embodiment and differing therefrom as follows: The cartridge port 34 includes a secondary puncturing member 39 for venting purposes. The secondary puncturing member 39 including an axially directed major segment 41 for puncturing a cartridge's rubber stopper 27, and a radial directed minor segment 42 vented to atmosphere. The puncturing members 38 and 39 are offset to the longitudinal axis 32 for off center puncturing of a cartridge's rubber stopper 27, thereby leaving its center intact for often repeated puncturing by hypodermic needles for administration purposes. The primary puncturing member 38 is elongated and includes a blocked tip 43 and a side hole 44 with a longitudinal axis 46 perpendicular to the housing's longitudinal axis 32 (see FIG. 4) This arrangement reduces bubbling of contents on injection of liquid contents into a cartridge 20 to minimize the possibility of contents contacting the secondary puncturing member 39.

FIG. 5 shows the fluid transfer device 50 is similar to the vented embodiment of the fluid transfer device 30 and therefore similar parts are likewise numbered. Accordingly, the fluid transfer device 50 includes the housing 31 with a tubular vial adapter port 52 intermediate the syringe port 33 and the cartridge port 34. The vial adapter port 52 rotatably supports a flow control member 53 with an axis of rotation 53A generally perpendicular to the housing's longitudinal axis 32. The vial adapter port 52 is provided with a vial adapter 54 for snap fitting onto a vial 70. The vial adapter 54 is preferably initially coupled to the housing 31 and rotationally detachable therefrom on a clockwise quarter turn rotation. The vial adapter 54 includes a hollow cannula 56 for puncturing the vial's rubber stopper 72 for flow communication with the bottle 71's interior. The vial adapter 54 engages the flow control member 53 for rotating same from an initial flow control position for enabling flow communication between the syringe port 33 and a vial inserted in the vial adapter 54 and a subsequent flow control position for enabling flow communication between the syringe port 33 and the cartridge port 34 prior to detachment from the housing 31.

The cartridge port's leading portion 36 can be optionally formed with an inwardly directed rim 36A adjacent its juncture with its trailing portion 37 for a snap fit sliding insertion of a cartridge 20 thereinto. The rim 36A can be a single annular rim or be formed from spaced apart rim segments. The cartridge port's trailing portion 37 is preferably constituted by a multitude of spaced apart elongated members 58 to extend midway along a cartridge 20. The trailing portion 37 preferably includes a peripheral flange 57 towards its free end (see FIG. 1B). The cap 51 includes a base member 59 with a pair of opposite side members 61 provided with finger operated members 62 for resiliently outwardly flexing the side members 61 relative to the base member 59 for enabling removable rigid attachment of the cap 51 onto the cartridge port's trailing portion 37. The cap 51 includes a stopper 63 for sliding insertion into a cartridge's trailing end 26 from a trailing direction for stopping ejection of the cartridge's seal 29 during a filling procedure for filling same. Caps 51 can be provided with stoppers 63 of different lengths.

While the invention has been described with respect to a limited number of embodiments, it will be appreciated that many variations, modifications, and other applications of the invention can be made within the scope of the appended claims. For example, fluid transfer devices 30 can be implemented for use with caps 51 and provided with an inwardly directed rim 36A. Also, fluid transfer devices 50 can be used with plugs 21 instead of caps 51.

1-11. (canceled)

12. A fluid transfer device for use with a syringe, and a cartridge having an open ended tube with a longitudinal axis, and hermetically sealed by a rubber stopper and a slidable seal respectively at opposite leading and trailing ends,
the device comprising a housing with a longitudinal axis, a syringe port and a cartridge port for correspondingly slidingly receiving the syringe and the cartridge, and said cartridge port having a primary puncturing member for puncturing the cartridge's rubber stopper for effecting flow communication between the syringe and the cartridge.

13. The device according to claim 12 wherein said primary puncturing member punctures the cartridge's rubber stopper offset with respect to the cartridge's longitudinal axis.

14. The device according to claim 12 wherein said primary puncturing member includes a blocked tip and a side hole with a longitudinal axis substantially perpendicular to said housing's longitudinal axis.

15. The device according to claim 12 wherein said cartridge port includes a secondary puncturing member for puncturing the cartridge's rubber stopper offset with respect to the cartridge's longitudinal axis for venting the cartridge during a filling procedure for filling the cartridge.

16. The device according to claim 15 wherein said primary puncturing member is elongated with respect to said secondary puncturing member.

17. The device according to claim 12 wherein said cartridge port includes a stepped internal cross section including a narrow diameter leading portion adjacent said syringe port for snugly receiving the cartridge's leading end, and a wide diameter trailing portion for snugly receiving the cartridge's trailing end.

18. The device according to claim 17 wherein said cartridge port's leading portion includes an inwardly directed rim adjacent its juncture with said trailing portion for snap fittingly receiving a cartridge therein.

19. The device according to claim 17 and further comprising a cap for manual removable rigid attachment onto said wide diameter trailing portion and including a stopper for sliding insertion into the cartridge's trailing end from a trailing direction for stopping ejection of the cartridge's seal during a filling procedure for filling the cartridge.

20. The device according to claim 12 and further comprising a plug for manual removable sliding insertion into the cartridge's trailing end from a trailing direction for stopping ejection of the cartridge's seal during a filling procedure for filling the cartridge.

21. The device according to claim 12 wherein said syringe port and said primary puncturing member are in direct continuous flow communication.

22. The device according to claim 12 and for additional use with a vial having a rubber stopper wherein said housing further comprises a tubular vial adapter port intermediate said syringe port and said cartridge port,
said vial adapter port rotatably supporting a flow control member having an axis of rotation generally perpendicular to said longitudinal axis and having a vial adapter for snap fittingly receiving the vial therein, said vial adapter having a hollow cannula for puncturing the vial's rubber stopper, and engaging said flow control member for rotating same from an initial flow control position for enabling flow communication between said syringe port and a vial inserted in said vial adapter and a subsequent flow control position for enabling flow communication between said syringe port and said cartridge port.
